(19) United States
(12) Patent Application Publication
(10) Pub. No.: US 2025/0175553 A1
(43) Pub. Date: May 29, 2025

(54) Test of a Communication Interface Connected to an Analog Telephone Line

(71) Applicant: SAGEMCOM BROADBAND SAS, Bois-Colombes (FR)

(72) Inventors: Laurent Capdevielle-fidel, Bois-Colombes (FR); Brice Meunier, Bois-Colombes (FR)

(21) Appl. No.: 18/960,909

(22) Filed: Nov. 26, 2024

(30) Foreign Application Priority Data
Nov. 27, 2023 (FR) 2313089

(51) Int. Cl. H04M 3/22; H04M 19/00

(52) U.S. Cl. CPC H04M 3/2272; H04M 19/001

(57) ABSTRACT

A method for testing a communication interface connected to an analog telephone line including two electrical wires, the method including the following steps: if it is detected that the communication interface switches into an off-hook state, collecting measurements acquired by the communication interface; if the measurements have nominal values, implementing a processing operation. During the processing operation, if it is detected that the communication interface is maintained in the off-hook state for a predefined duration, ordering a complementary test on the telephone line; if the test reveals a fault in the analog telephone network, issuing an alarm, and otherwise repeating the processing operation.

### CROSS REFERENCE TO RELATED APPLICATIONS

The benefit of priority to French Patent Application No. 2313089 filed Nov. 27, 2023 is hereby claimed, and the disclosure is incorporated herein by reference in its entirety.

### TECHNICAL FIELD

The present disclosure relates in particular to a method for testing a communication interface connected to an analog telephone line.

### STATE OF THE ART

A component used as a communication interface between an analog telephone network and a digital network providing access, for example, to a voice over IP (Voice Over Internet Protocol) service is the FXS (Foreign exchange subscriber) port.

A FXS port can take both states:
a state called “off-hook” state when the FXS port considers to be connected via an analog telephone line to an off-hook telephone set (in other words, when the FXS port considers that the analog telephone line is busy), and
a state called “on-hook” state when the FXS port considers not to be connected to any off-hook telephone set (in other words, when the FXS port considers that the analog telephone line is not busy).

The FXS port can be declared in the off-hook state for various reasons: due to a malfunction of the FXS port, due to a problem in the connection of the FXS port to the analog telephone network, or because the analog telephone line is truly busy, either by an ongoing call or because a user has voluntarily put his telephone off-hook so as not to be disturbed.

To differentiate between these different cases, it is known to order to the FXS port the implementation of tests on the telephone line that are defined in the standard known to those skilled in the art under the name GR-909 (the name of the specification describing the content of this standard is “GR909-CORE: Generic Criteria for Fiber in the Loop Systems”). However, these tests are not always accurate.

Other tests have been proposed in document U.S. Pat. No. 6,438,212B1, but these have the disadvantage of requiring external equipment as well as the intervention of a user.

### DISCLOSURE OF THE INVENTION

One aim of the invention is to test a communication interface with an accurate analog telephone network that does not require external equipment.

For this purpose, according to a first aspect, a method is proposed for testing a communication interface connected to an analog telephone line comprising two electrical wires, the method comprising the following steps:
detecting a change of state of the communication interface between an off-hook state and an on-hook state;
if it is detected that the change of state switches from the on-hook state to the off-hook state, collecting measurements acquired by the communication interface, the measurements relating to at least one of the following physical quantities:
   a voltage provided by a converter of the communication interface,
   a voltage between the two electrical wires,
   an intensity of a loop current flowing in one of the two electrical wires,
   an intensity of a leakage current from one of the two electrical wires to a ground of the communication interface;
verifying the matching of the measurements with respective nominal values;
if the verification reveals that all the measurements have nominal values, implementing a processing operation comprising the following steps:
   detecting a maintenance of the state of the communication interface for a predefined duration;
   if it is detected that the communication interface is maintained in the off-hook state for the predefined duration, ordering a complementary test on the telephone line by the communication interface, so as to collect diagnostic data complementary to the measurements;
   if the complementary diagnostic data reveal a fault in the analog telephone network, issuing an alarm;
   if the complementary diagnostic data do not reveal a fault on the analog telephone line, repeating the processing operation.

The method can also comprise the following optional characteristics, taken alone or combined with each other whenever technically possible.

Optionally, the method comprises the following steps: if the verification of the measurements reveals that at least one measurement among the voltage between the two electrical wires, the intensity of the loop current and the intensity of the leakage current does not have a nominal value, ordering the complementary test on the telephone line by the communication interface, so as to obtain the diagnostic data complementary to the measurements, and issuing the alarm if the diagnostic data reveal a fault in the analog telephone network.

Optionally, the method comprises the following steps:
if the verification of the measurements reveals that the voltage provided does not have a nominal value, ordering the restart of the converter of the communication interface;
if the verification of the voltage provided has a nominal value, verifying the matching of at least one measurement with respective nominal values, the measurements relating to at least one of the following physical quantities:
   the voltage between the two electrical wires,
   the intensity of the loop current,
   the intensity of the leakage current.

Optionally, the method comprises the following steps implemented if it is detected that the change of state switches from the off-hook state to the on-hook state or if the communication interface is maintained in the on-hook state,
collecting a voltage between the two electrical wires acquired by the communication interface;
verifying the collected voltage, so as to determine whether the collected voltage has a nominal value;
if the voltage has a nominal value, implementing the processing operation;
if the voltage does not have a nominal value, accessing information stored by the communication interface, the information indicating whether or not the communication interface has received a power supply order from the analog telephone line;
if the information indicates that the communication interface has not received a power supply order, then ordering the communication interface so that the communication interface supplies the analog telephone line;
if the information indicates that the communication interface has received a power supply order, ordering the restart of the converter.

Optionally, the method further comprises the following steps implemented after the order of the communication interface so that the communication interface supplies the analog telephone line:
collecting new measurements acquired by the communication interface, the new measurements relating to at least one of the physical quantities;
verifying the matching of the new measurements with the respective nominal values;
if the verification of the matching of the new measurements reveals that all the new measurements have nominal values, implementing the processing operation;
if the verification of the matching of the new measurements reveals that at least one of the new measurements does not have a nominal value, ordering the restart of the converter.

Optionally, the method further comprises the following steps implemented after the converter restart order:
repeating the steps of collecting and verifying new measurements;
if the repetition of the steps of collecting and verifying new measurements reveals that all the new measurements have nominal values, implementing the processing operation;
if the repetition reveals that a new measurement does not have a nominal value, ordering the hard reset of the communication interface.

Optionally, the method further comprises the following steps implemented after the hard reset order of the communication interface:
repeating a second time the steps of collecting and verifying new measurements;
if the second repetition reveals that all the new measurements have nominal values, implementing the processing operation;
if the second repetition reveals that a new measurement does not have a nominal value, issuing an alarm.

Optionally, the complementary test comprises at least one test defined by the GR-909 standard.

A second aspect of the present disclosure is a computer program product comprising program code instructions for the execution of the steps of the method above, when this program is executed by a processor.

A third aspect of the present disclosure is a device, for example an internet access gateway, comprising:
a communication interface suitable to be connected to an analog telephone line comprising two electrical wires;
a processor configured to test the communication interface using the method described above.

### DESCRIPTION OF THE FIGURES

Other characteristics, aims and advantages of the invention will emerge from the following description, which is purely illustrative and non-limiting, and which should be read in relation to the appended drawings in which:

FIG. 1 schematically illustrates a device 1 according to a first embodiment of the invention.

FIG. 2 shows voltage values supposed to be used by an FXS port in an off-hook state and in an on-hook state.

FIG. 3, FIG. 4 and FIG. 5 are flowcharts of steps of a method according to one embodiment.

In all of the figures, similar elements bear identical references.

### DETAILED DESCRIPTION OF THE INVENTION

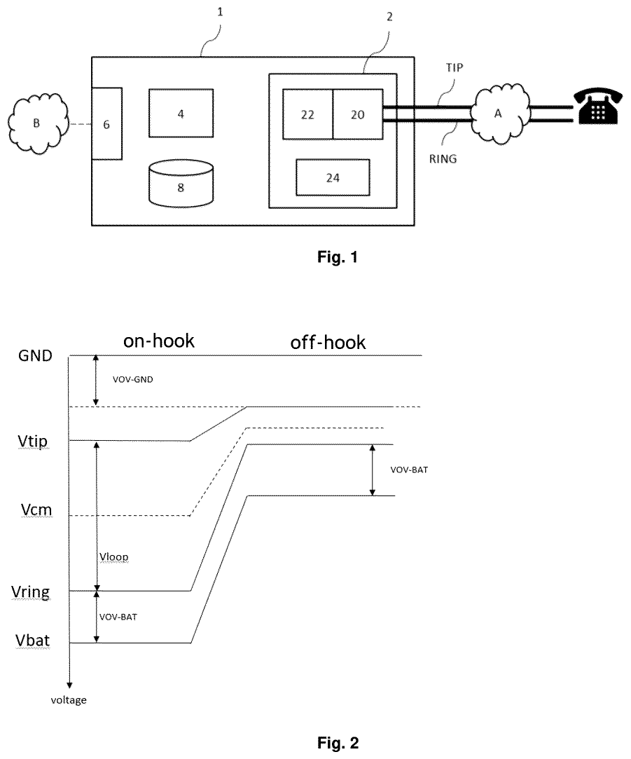

With reference to FIG. 1, a device 1, such as an Internet gateway, comprises a first communication interface 2 with an analog telephone network A, a processor 4, and a second communication interface 6 with a digital network B, for example a WAN (Wide Area Network).

In the remainder of the present disclosure, a non-limiting embodiment will be considered in which the first communication interface 2 with the analog telephone network is, or comprises, an FXS (Foreign exchange subscriber) port.

The FXS port is suitable to be connected to an analog telephone via an analog communication line comprising two electrical wires conventionally called TIP and RING.

A function ensured by the FXS port is to ensure the correct operation of the connected analog telephone, to transmit and receive the signaling necessary for carrying out an analog communication (voltage and current supply of the telephone line, ringing signal during an incoming call, state of the loop).

The electrical communication line can thus comprise a cable suitable to be removably connected to the device 1 and to the analog telephone. This cable can comprise, for example, an RJ11 connector.

The FXS port comprises a line interface 20, or LIF, comprising two electrical contacts suitable to be electrically connected respectively to the first electrical wire and to the second electrical wire of the analog telephone line.

The FXS port also comprises a subscriber line interface circuit 22, or SLIC circuit (Subscriber Line Interface Circuit). The SLIC circuit is configured to perform some processing operations, for example an audio conversion between an analog signal coming from the analog telephone and the digital network connected to the gateway. Other processing operations (gains, transcoding, echo cancellation) can also be carried out by the SLIC circuit or by the processor 4.

The FXS port further comprises a converter 24 configured to electrically supply the other components of the FXS port (SLIC, LIF) as well as the analog communication line, and the analog telephone that is possibly connected thereto. The converter 24 is a DCDC converter, that is to say it provides the analog communication line with an output direct current from an input direct electric current it receives, and which is of different intensity. The input electric current emanates from an electric current source external to the device 1.

The converter 24 is capable of generating different voltages depending on the operating mode of the FXS port. These voltages are for example higher than the general supply voltage of the gateway provided by the external source (12 Volts in France).

In a manner known per se, an analog telephone is likely to be in an off-hook state or in an on-hook state. These state names refer to the fact that an analog telephone can comprise a base and a telephone handset comprising a loudspeaker and a microphone, the telephone handset being likely to be put off-hook from the base or to be put on-hook thereon.

When the analog telephone is in the off-hook state, the analog telephone establishes communication with the FXS port exclusively. The telephone then receives electric current via one of the two electrical wires of the telephone line and retransmits the electric current received via the other electrical wire of the line, thus forming a current loop. It is then conventionally said that the telephone line is “busy” by the analog telephone. A telephone user is notified of the off-hook state by a tone. The user can then dial a telephone number to establish a telephone communication with a recipient.

When the analog telephone is in the on-hook state, no communication is established with the FXS port. No current flows in the two electrical wires of the analog telephone line.

FIG. 2 represents the voltage values that are supposed to be used in the off-hook state and in the on-hook state. These voltages are negative with respect to the ground of the FXS port. These voltages are as follows:
GND: the ground reference,
Vbat: voltage provided by the converter,
Vring: voltage between the electrical wire RING and the ground,
Vtip: voltage between the electrical wire TIP and the ground,
Vloop: voltage between the two electrical wires TIP and RING,
VOV_GND and VOV_BAT: predefined offset voltages allowing the transmission of audio signals,
Vcm: arbitrary reference voltage, equal to (Vtip+Vring)/2.

The FXS port comprises a memory configured to store various measurements relating to the analog telephone line. This memory is for example included in the SLIC circuit 22. These measurements comprise the aforementioned voltages and represented in FIG. 2, as well as the intensity of the following currents:
Iloop: intensity of the current flowing in the electrical wires TIP and RING in two opposite directions, which will be called “loop current” in the present disclosure,
Ilong: intensity of a leakage current from the electrical wire TIP or RING to the ground.

The FXS port comprises an internal measuring apparatus adapted to measure the aforementioned voltages and current intensities, and to regularly update the information stored in the memory, for example periodically, so that the measurements stored in these registers at a given time strive to reflect the state of the analog telephone line at that given time.

The memory comprises, for example, 32-bit registers, each register storing one of the aforementioned measurements.

For example, the least significant bit of a register of the memory for a voltage is equal to 931.323-9 Volts. For example, the least significant bit of a register of the memory for a current is equal to 1.676-9 Amperes.

The memory is also configured to store a boolean estimating whether the FXS port is in an off-hook state or in an on-hook state (the value of this boolean is automatically adjusted by the SLIC circuit). This information indicates that:
the FXS port is in the off-hook state when the FXS port considers to be connected via the analog telephone line to an off-hook telephone set (that is to say when the FXS port considers that the analog telephone line is busy), and that
the FXS port is in the on-hook state when the FXS port considers not to be connected to any off-hook telephone set (that is to say when the FXS port considers that the analog telephone line is not busy).

In practice, this Boolean can be coded on a single bit.

The processor 4 is configured to execute a computer program performing various functionalities, in particular order the operation of the FXS port. For this, the program comprises or is combined with a dedicated driver of the FXS port, this driver comprising different code functions.

Some code functions of the driver place to the FXS port orders requesting the FXS port to perform tests on the analog telephone line, for example tests defined in the GR-909 standard cited in the introduction of the present disclosure. These tests are set out in the parts 12.4.6 (Interface to Embedded Loop Testing Systems) and 12.4.7 (Generic Testing Interface) of the specification of the GR-909 standard.

Other code functions of the driver allow read access to the information stored in the memory of the FXS port.

The computer program is itself stored in a memory 8 of the device 1, external to the FXS port.

A method for testing the FXS port implemented by the processor 4, when this processor 4 executes the aforementioned computer program, will now be described.

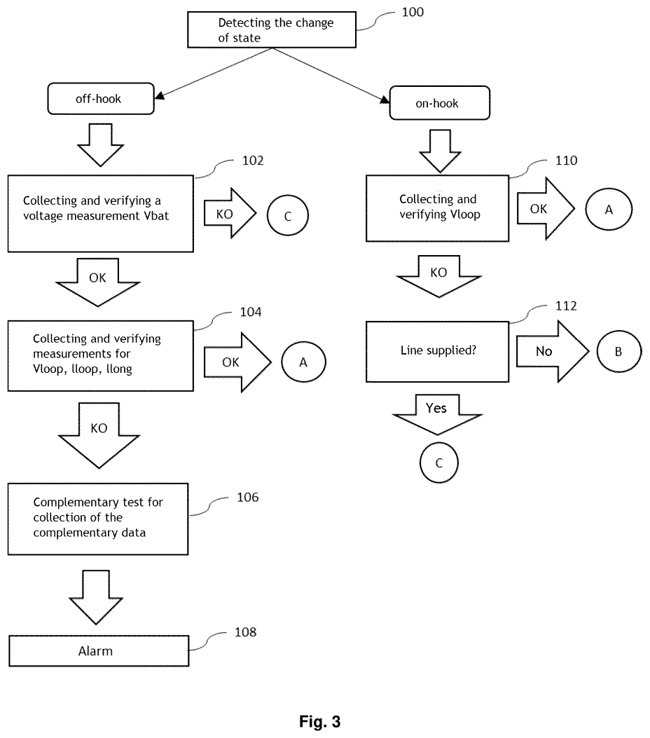

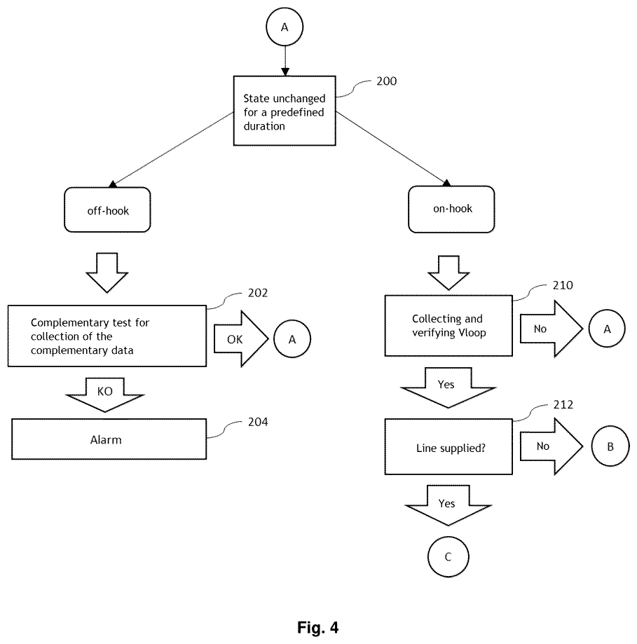

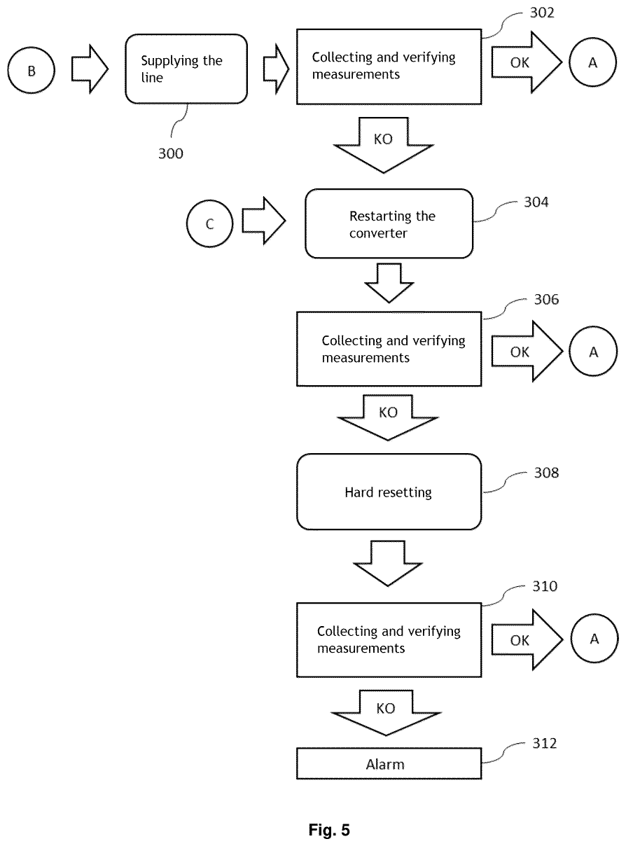

With reference to FIG. 3, the processor 4 detects in a step 100 a change of state of the FXS port. There are two possible changes of state: an off-hook (the FXS port switches from the on-hook state to the off-hook state) or an on-hook (the FXS port switches from the off-hook state to the on-hook state).

This detection step 100 can be carried out for example by read accessing the register of the memory of the FXS port storing the boolean indicative of its state, and this repeatedly over time, for example periodically. A reading of a zero followed by a 1 or a 1 followed by a zero reflects a change of state.

If the processor 4 detects an off-hook, then the processor 4 collects measurements acquired by the FXS port, by read accessing the corresponding registers of the memory of the FXS port. The measurements relate to at least one of the following physical quantities:
the voltage Vbat provided by the converter,
the voltage Vloop between the two electrical wires,
the intensity Iloop of the loop current flowing in the first electric wire or in the second electric wire,
the intensity Ilong of the leakage current.

For each physical quantity measurement collected, the processor 4 verifies a matching between the collected measurement and a nominal value of the physical quantity. A nominal value is an expected value for the physical quantity considered, reflecting normal operation.

The processor 4 can verify such a matching by comparing the measurement with the nominal value, the latter having been stored by the device 1 beforehand. If it is found that the deviation between the measurement and the stored nominal value is below a threshold (the threshold can be equal to zero or different from zero to reflect a tolerance margin), then it is considered that the measurement corresponds to a nominal value. If it is found that this deviation is above the threshold, it is considered that the measurement does not correspond to a nominal value.

Alternatively, the processor 4 can verify such a matching by comparing the measurement with an abnormal value stored by the device 1 beforehand (this value is said to be abnormal because it represents an abnormal situation). If it is found that the deviation between a measurement and the stored abnormal value is below a threshold (the threshold may be equal to zero or different from zero to reflect a tolerance margin), then it is considered that the measurement does not correspond to a nominal value. If it is found that this deviation is above the threshold, it is considered that the measurement corresponds to a nominal value.

If the verification of the measurements reveals that all the measurements correspond to nominal values, then the situation is considered normal, and the processor 4 implements a cyclic test processing which is represented in FIG. 3 by the block A. This cyclic test processing will be detailed later.

Preferably, the measurements are verified in two successive verification steps 102 and 104.

In the first verification step 102, the processor 4 verifies whether the measured voltage Vbat corresponds to a non-zero nominal voltage value stored by the device 1. The processor 4 can for example use a tolerance margin, for example 5%.

If the measured voltage Vbat does not correspond to the nominal value (that is to say the deviation between Vbat and the nominal value is greater than the tolerance margin), then the method switches to block B. Block B is representative of an error case which triggers the implementation of some steps of the method which will be described later.

If, on the contrary, the measured voltage Vbat corresponds to the nominal value, then the processor 4 switches to the second verification step 104, during which the processor 4 verifies whether the other collected measurements (Vloop, Iloop, Ilong) correspond to nominal values.

An abnormal value for the voltage Vloop is a zero value. Indeed, such a zero value would reflect a short circuit between the first electrical wire and the second electrical wire. Under these conditions, the processor 4 considers that the measured voltage Vloop is nominal if and only if the voltage Vloop is in absolute value above a threshold constituting the chosen tolerance margin (equal to zero or close to zero).

A nominal value for the intensity Iloop of the loop current is a predefined non-zero value Iref stored by the device 1. Under these conditions, the processor 4 considers that the measured intensity Iloop is nominal if and only if a deviation between Iloop and this predefined non-zero value is below a threshold constituting the chosen tolerance margin (equal to zero or close to zero). Otherwise, a resistance fault probably occurs.

A nominal value for the intensity Ilong of the leakage current is a zero value. Indeed, a non-zero value would reflect a current leak from the analog telephone line to the ground. Under these conditions, the processor 4 considers that the measured intensity Iloop is nominal if and only if Iloop is in absolute value below a threshold constituting the chosen tolerance margin (equal to zero or close to zero).

Ultimately, the Vloop, Iloop and Ilong measurements correspond to nominal values if the following relationships are all met, to within a tolerance margin:

$$Vloop = 0$$

$$Iloop \neq Iref$$

$$Ilong \neq 0$$

As indicated previously, the method switches to block A if all these relationships are met.

If on the contrary at least one of the following relationships is not met, otherwise if at least one of the Vloop, Iloop and Ilong measurements does not correspond to a nominal value, then the processor 4 orders, in a step 106, the implementation by the FXS port of a complementary test of the telephone line, so as to collect diagnostic data complementary to the measurements.

The complementary test comprises at least one of the following tests, defined by the GR-909 standard.

| | Name of the test in | |
|---|---|---|
| | GR-909 | Collected complementary data |
| #1 | Hazardous Potential and | Residual voltage measured between the |
| | Foreign Electrical | wires TIP and RING |
| | Motive Force test | Residual voltage measured between the |
| | | wire TIP and the ground |
| | | Residual voltage measured between the |
| | | wire RING and the ground |
| #2 | Resistive Faults Test | Impedance measured between the wires |
| | | TIP and RING |
| | | Impedance measured between the wire |
| | | TIP and the ground |
| | | Impedance measured between the wire |
| | | RING and the ground |
| #3 | Receiver Off Hook test | Specific impedance test: an off-hook set |
| | | has a variable impedance depending on the |
| | | voltage between the wires TIP and RING |

For example, the complementary test can first comprise tests #1 and #2, and only comprises test #3 if tests #1 and #2 do not reveal a fault. Test #3 is actually an impedance consistency test for verifying the presence of an off-hook analog telephone. This test is capable of differentiating between an off-hook telephone and an impedance of similar value.

Tests #1, #2 and #3 can be performed in any order. For example, the complementary test can first comprise test #3 and then tests #1 and #2.

Once these complementary data have been collected, the processor 4 issues an alarm (step 108).

This alarm can be communicated to a user of the device 1, for example in the form of a message displayed on a display screen of the device 1. As a variant or additionally, the alarm is transmitted to a maintenance server via the first communication interface. In this way, the user and/or the maintenance organization of the device 1 is informed of the existence of a malfunction of the analog telephone network. The collected complementary data characterize and quantify this malfunction. These complementary data can indeed indicate the location of the malfunction (at the FXS port, at the analog telephone, or at the analog telephone line) and/or quantify the malfunction (for example via the collected impedance measurements).

Steps performed by the processor 4 when an off-hook is detected have been described so far.

When the processor 4 detects, on the contrary, an on-hook (switching of the state of the FXS port from the off-hook state to the on-hook state), the processor 4 implements the following steps.

In a step 110, the processor 4 collects the voltage Vloop measured by the FXS port, and verifies whether this voltage Vloop is nominal (in accordance with the rule described above). If so, the situation is normal, and the method switches to block A. Otherwise, the processor 4 implements the step 112.

In the step 112, the processor 4 accesses information stored in the memory of the FXS port, the information indicating whether or not the communication interface has received a power supply order from the analog telephone line. If so, the method switches to block B. Otherwise, the method switches to block C.

Unlike block A, which reflects a normal situation, blocks B and C reflect two abnormal situations to different degrees.

The cyclic test processing materialized by block A in FIG. 3 will now be detailed. This cyclic test processing comprises the following steps, represented in FIG. 4.

In a step 200, the processor 4 detects that the state of the FXS port (on-hook state or off-hook state) is maintained for a predefined duration. The predefined duration can be greater than one hour, or even greater than 6 hours, or even greater than 12 hours, or even greater than 24 hours. In all cases, the predefined duration is significantly greater than the reading period of the Boolean indicative of this state.

If the processor 4 detects that the FXS port is maintained in the off-hook state for the predefined duration, then the processor 4 switches to step 202.

In step 202, the processor 4 orders a complementary test on the analog telephone line, so as to collect the complementary diagnostic data, in accordance with step 106 described above.

In step 202, the processor 4 also verifies whether or not these complementary diagnostic data reveal a fault in the analog telephone network. Such a fault can be encountered at the FXS port, at the analog telephone, or at the analog telephone line between the two.

If the diagnostic data reveal a fault in the analog telephone network, the processor 4 implements a step 204 of issuing an alarm, which can be identical to step 108.

If the diagnostic data do not reveal a fault in the analog telephone network, then the processor 4 returns to block A. The steps described above could then be implemented again upon detection of a maintenance of the state for the predefined duration.

If the processor 4 detects in step 200 that the FXS port is maintained in the on-hook state for the predefined duration, then the processor 4 implements steps 210, 212 identical to steps 110 and 112 according to the same logic and the same consequences as in the case of detection of an on-hook described above. The implementation of steps 210, 212 can thus result in block A, B or C depending on the case.

The steps implemented by the processor 4 when the method is in block B with reference to FIG. 5 will now be detailed (it is recalled that this situation occurs if the processor 4 arrives at the conclusion that the FXS port has not received a power supply order to supply the analog telephone line).

In this situation, the processor 4 orders the FXS port so that the FXS port supplies the analog telephone line (step 300). To this end, the processor places to the FXS port an appropriate power supply order.

Then, in a step 302, the processor 4 collects new measurements for the physical quantities discussed previously, then verifies the matching of each new measurement with a nominal value. Thus, step 302 corresponds to steps 102 and 104 represented in FIG. 1.

If the verification carried out during step 302 reveals that all the new measurements have nominal values, then the method switches to block A (normal situation). If the verification reveals that at least one of the new measurements does not have a nominal value, then the method switches to step 304.

In step 304, the processor 4 orders a restart of the FXS port converter, using an appropriate order.

Then, in a step 306, the processor 4 collects new measurements for the physical quantities discussed previously, then verifies the matching of each new measurement with a nominal value. This step is identical to step 302.

If the verification reveals that all the new measurements have nominal values, then the method switches to block A (normal situation). If the verification reveals that at least one of the new measurements does not have a nominal value, then the method switches to step 308.

In step 308, the processor 4 orders hard reset of the FXS port. The processor 4 can also restart the program it is executing, or at least a module of the program using the FXS port, for example a communication management module between the telephone network and a VOIP service accessible via the digital network.

Then, in a step 310, the processor 4 collects new measurements for the physical quantities discussed previously, then verifies the matching of each new measurement with a nominal value. This step is identical to step 302.

If the verification reveals that all the new measurements have nominal values, then the method switches to block A (normal situation). If the verification reveals that at least one of the new measurements does not have a nominal value, then the processor 4 issues an alarm in a step 312 (which can be identical to step 108).

The steps implemented by the processor 4 when the method is in block C will now be detailed (it is recalled that this situation occurs if the processor 4 concludes that the FXS port has received a power supply order to supply the analog telephone line).

In this case, the method switches directly to the converter restart step 304, then implements the steps subsequent to the converter restart step described in case B.

One example of implementation of the method with nominal values finding application in France for example will now be detailed.

The FXS is configured to provide a resting voltage of 47 Volts and an off-hook current of 36 mA. The VOV_GND and VOV_BAT offsets are set to 5.25 Volts.

Upon detection of an off-hook, the processor 4 collects the following measurements: Vbat=26.83 Volts, Vtip=5.47 Volts, Vring=22.46 Volts.

Here, Vbat seems correct since Vbat>Vtip, but we notice that we do not have the relationship Vbat=Vtip+VOV_BAT.

The processor 4 then verifies the other measurements. It notes that:
Vloop=Vtip−Vring=19.99 Volts (which is different from 0 Volt).
Iloop=35.46 mA; with a tolerance of 5%, we have the predefined loop current (36 mA).
Ilong=0.31 mA; with a margin of error, this value can be considered zero.

We are thus in a situation where all the collected measurements have nominal values; the method therefore switches to the cyclic processing (block A). After waiting for the predefined duration, the processor 4 notes that the FXS port has been maintained in the off-hook state. The processor 4 then implements the complementary test. Particularly, test #3 “Receiver Off-Hook” indicates that the off-hook state perceived by the FXS port is not caused by an analog telephone. Under these conditions, the processor 4 implements test #2, thus making it possible to collect the following impedances:
Impedance between the wire TIP and the ground: 2,000,000 ohms
Impedance between the wire RING and the ground: 2,000,000 ohms.
Impedance between the wires TIP and RING: 220 ohms.

These values reveal the existence of a fault, because the impedance measured between the wires TIP and RING is lower than that of an ordinary set in working condition (impedance comprised between 400 and 600 ohms). The alarm is therefore triggered.

The processor 4 is capable of executing instructions loaded into the memory 8 from a “Read Only Memory” or “ROM”, an external memory (such as a memory card such as a “Secure Digital” or “SD” card), a storage medium (such as a hard disk), or a communication network. When the device 1 is powered up, the processor 4 is capable of reading instructions from the memory 8 and executing them. These instructions form a computer program causing the implementation, by the processor 4, of all or part of the behaviors, processing operations, algorithms and steps described here.

Thus, all or part of the algorithms, processing operations and steps described herein can be implemented in software form by executing a set of instructions by a programmable machine, such as a DSP (Digital Signal Processor) or a microcontroller or a processor. All or part of the algorithms, processing operations and steps described herein can also be implemented in hardware form, or in the form of the combination of a hardware form and a software form, by a machine or a component (chip), such as an FPGA (Field-Programmable Gate Array) or an ASIC (Application-Specific Integrated Circuit). Thus, the device 1 includes electronic circuitry adapted and configured to implement the behaviors, processing operations, algorithms and steps described herein.

1. A method for testing a communication interface connected to an analog telephone line comprising two electrical wires, the method comprising the following steps:
detecting (100) a change of state of the communication interface between an off-hook state and an on-hook state;
if it is detected that the change of state switches from the on-hook state to the off-hook state, collecting measurements acquired by the communication interface, the measurements relating to at least one of the following physical quantities:
a voltage provided (Vbat) by a converter of the communication interface,
a voltage (Vloop) between the two electrical wires,
an intensity of a loop current (Iloop) flowing in one of the two electrical wires,
an intensity of a leakage current (Ilong) from one of the two electrical wires to a ground of the communication interface;
verifying (102, 104) the matching of the measurements to respective nominal values;
if the verification reveals that all the measurements have nominal values, implementing a processing operation comprising the following steps:
detecting (200) a maintenance of the state of the communication interface for a predefined duration;
if it is detected that the communication interface is maintained in the off-hook state for the predefined duration, ordering (202) a complementary test on the telephone line by the communication interface, so as to collect diagnostic data complementary to the measurements;
if the complementary diagnostic data reveal a fault in the analog telephone network, issuing (204) an alarm;
if the complementary diagnostic data do not reveal a fault on the analog telephone line, repeating the processing operation.

2. The method according to the preceding claim, further comprising the following steps:
if the verification reveals that at least one measurement among the voltage (Vloop) between the two electrical wires, the intensity of the loop current (Iloop) and the intensity of the leakage current (Ilong) does not have a nominal value, ordering (202) the complementary test on the telephone line by the communication interface, so as to obtain the diagnostic data complementary to the measurements, and issuing the alarm if the diagnostic data reveal a fault in the analog telephone network.

3. The method according to any one of the preceding claims, comprising the following steps implemented if it is detected that the change of state switches from the off-hook state to the on-hook state or if the communication interface is maintained in the on-hook state,
collecting a voltage (Vloop) between the two electrical wires acquired by the communication interface;
verifying (110, 210) the voltage (Vloop) between the two electrical wires, so as to determine whether the collected voltage has a nominal value;
if the voltage (Vloop) between the two electrical wires has a nominal value, implementing the processing operation;
if the voltage (Vloop) between the two electrical wires does not have a nominal value, accessing (112) information stored by the communication interface, the information indicating whether or not the communication interface has received a power supply order for the analog telephone line;
if the information indicates that the communication interface has not received a power supply order, then ordering (300) the communication interface so that the communication interface supplies the analog telephone line;
if the information indicates that the communication interface has received a power supply order, ordering (304) the restart of the converter.

4. The method according to the preceding claim, further comprising the following steps implemented after the order of the communication interface so that the communication interface supplies the analog telephone line:
collecting new measurements acquired by the communication interface, the new measurements relating to at least one of the physical quantities;
verifying (302) the matching of the new measurements with the respective nominal values;
if the verification of the matching of the new measurements reveals that all the new measurements have nominal values, implementing the processing operation;
if the verification of the matching of the new measurements reveals that at least one of the new measurements does not have a nominal value, ordering (304) the restart of the converter.

5. The method according to any one of claims 3 and 4, further comprising the following steps implemented after the converter restart order (304):
repeating (306) the steps of collecting and verifying new measurements;
if the repetition (306) of the steps of collecting and verifying new measurements reveals that all the new measurements have nominal values, implementing the processing operation;
if the repetition (306) reveals that a new measurement does not have a nominal value, ordering (308) the hard reset of the communication interface.

6. The method according to the preceding claim, further comprising the following steps implemented after the hard reset order of the communication interface:
repeating (308) a second time the steps of collecting and verifying new measurements;
if the second repetition (308) reveals that all the new measurements have nominal values, implementing the processing operation;
if the second repetition (306) reveals that a new measurement does not have a nominal value, issuing (312) an alarm.

7. A computer program product comprising program code instructions for the execution of the steps of the method according to any one of the preceding claims, when this program is executed by a processor (4).

8. A device (1), for example an internet access gateway, comprising:
a communication interface (2) suitable to be connected to an analog telephone line comprising two electrical wires (TIP, RING);
a processor (4) configured to test the communication interface (2) using the method according to any one of claims 1 to 7.
